(19) United States
(12) Patent Application Publication
(10) Pub. No.: US 2009/0301237 A1
(43) Pub. Date: Dec. 10, 2009

(54) Positioner utilizing engaged toothed gear belts, one static and one dynamic

(76) Inventor: Michael R. Everman, Goleta, CA (US)

Correspondence Address: DONALD D. MON;ATTORNEY AT LAW, SUITE 303, 750 EAST GREEN STREET, PASADENA, CA, 91101, US

(21) Appl. No.: 12/157,602

(22) Filed: Jun. 10, 2008

(51) Int. Cl. F16H 19/02

(52) U.S. Cl. 74/37

(57) ABSTRACT

A positioner controllably to shift an object linearly, utilizing a pair of mutually engageable gear belts, one of which is static and the other is dynamic. The dynamic gear belt includes a bight engaged to and driven by a rotary pinion. The gear belts are mutually engaged except for that part of the dynamic belt which is in the bight.

### FIELD OF THE INVENTION

A positioner controllably to shift an object linearly, utilizing a pair of mutually engageable gear belts, one of which is static, and the other of which is dynamic, the dynamic belt forming within its length a bight engaged by and driven by a rotary pinion, the gears being mutually engaged except for that part of the dynamic belt which is in said bight.

### BACKGROUND OF THE INVENTION

The function of a linear positioner is to move one object relative to another, the destination point being specified. The field is crowded with drive and control systems for this purpose. Movement of relatively light objects to a location that allows for dimension tolerance can be a simple matter. Difficulties arise when massive or extensive bodies must be moved against variable physical resistance, to close tolerances. One example is the positioning of a wooden workpiece and a router in woodwork manufacturing, for example in cabinetry and in furniture. The forces involved are large, a close dimensional tolerance is specified, and the environment is at best dirty.

The dirt is such as sawdust, chips and dust particles which can clog machinery and adversely affect production rates and quality. These are difficult situations, which this invention can overcome. Survival in adverse environments, rapid movement with close repeatable dimensional control and adaptability to conventional control circuitry are attained by the invention.

### BRIEF DESCRIPTION OF THE INVENTION

A positioner according to this invention includes a base, a carriage a static gear belt and a dynamic drive gear belt. The static gear belt is fixed in place, linear and planar. It includes a linear array of lateral teeth on an exposed side of the rack.

The dynamic drive gear belt is flexible, with a linear array of lateral teeth engageable with and disengageable from the teeth on the static gear belt. Between its ends, the dynamic drive gear belt includes a bight. The bight of the dynamic drive gear belt is disengaged from the static reference gear belt. At the central bend of the bight it is engaged by a drive pinion. The teeth of the static and dynamic gear belts are engaged for a substantial distance on each side of the bight.

A carriage mounts the drive pinion and a drive motor which drives the drive pinion, thereby moving the location of the bight along the dynamic drive gear belt, which will cause relative linear movement of the carriage and the base. If the carriage is fixed, structure to which the static gear belt is fixed (the base) will move. When the structure is fixed, the carriage will move. It depends on the application in which the system is employed.

According to optional features of this invention, the dynamic gear belt can engage substantially the entire length of the static belt, except in the bight.

According to yet another optional feature of this invention, the same fixed belt can be utilized along with a pair of dynamic gear belts each with individual bights, or one with two bights with two bights to control the relative movement of two carriages.

The above and other features of this invention will be fully understood from the following detailed description and the accompanying drawings, in which:

### BRIEF DESCRIPTION OF THE DRAWINGS

FIG. 1 is a perspective view of the preferred embodiment of this invention;

FIG. 2 is a side view of a portion of FIG. 1;

FIG. 3 is a schematic showing of the bight and related drive portions;

FIGS. 4 and 5 are fragmentary showings of the relationship of the idlers to the bight;

FIG. 6 is a schematic illustration of another embodiment of this invention; and

FIG. 7 is a detail of FIG. 6.

### DETAILED DESCRIPTION OF THE INVENTION

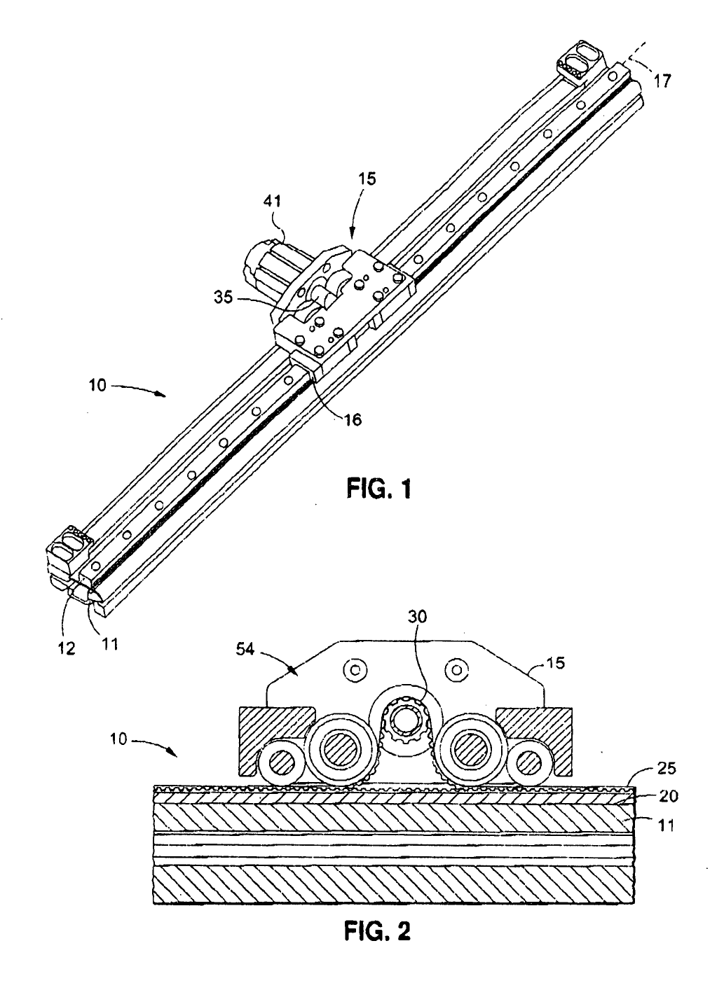

As shown in FIG. 1, a positioner 10 according to this invention includes a base 11 which incorporates a rail 12 for alignment purposes. As will later be evident, the term ▪base▪ is not limited to fixed structures. It often will be, but instead it may be the movable part of another arrangement.

A carriage 15 includes guides 16 by which it is movable along a linear axis 17, i.e. along rail 12. The term ▪carriage▪ is used for convenience. Instead of being movable, it might be fixed relative to a movable base. Whatever the arrangement, it is intended to move the base and carriage relative to each other so as to position something on the movable part relative to a fixed tool, or to put the tool on the movable part, and move it relative to a fixed workpiece. An example of the foregoing is to place a workpiece on a movable base and move it relative to a tool such as a router, which is mounted to the fixed carriage.

A static gear belt 20 is flat and is applied to a flat surface 21 on the base. It extends along axis 17 with straight teeth 23 which extend perpendicularly to axis 17. The details of the teeth will be discussed below.

A dynamic gear belt 25 has a smooth flat ▪back▪ surface 26 and a toothed ▪front▪ surface 27 with straight teeth 28 that are engageable to and separable from teeth 25. This belt is flexible and can be suitably bent toward and away from its teeth. Belt 25 directly overlays belt 20, and closes the spaces between all of the gears where it is engaged. This closes the spacing between the belts on them. This keeps the belts and teeth clear of debris.

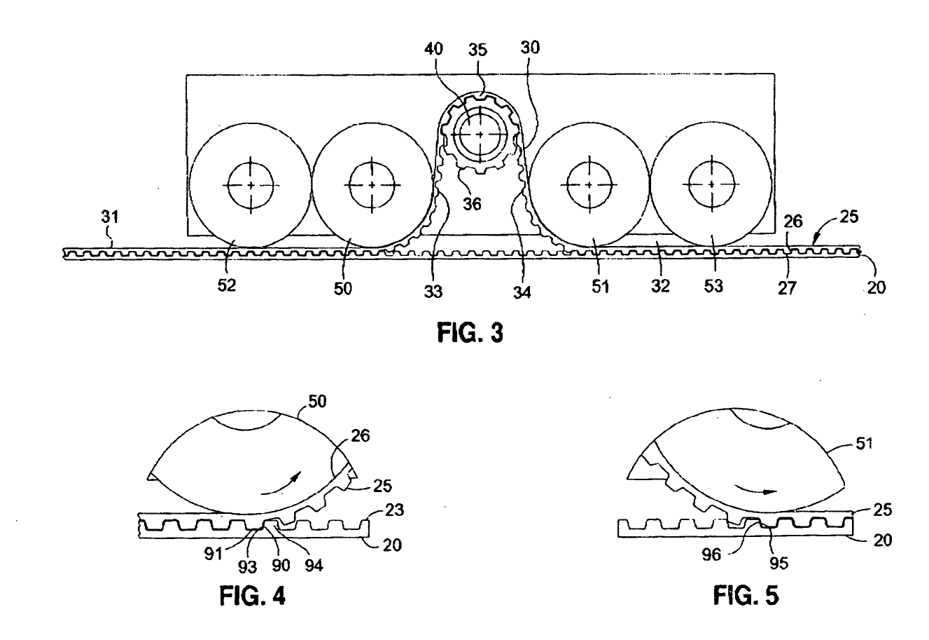

As best shown in FIG. 3, a portion of the dynamic gear belt is separated from the static gear belt to form a bight 30. This bight is between adjacent engaged lengths 31,32 on opposite sides of the bight from each other. As will be seen, the bight moves along the base as the positioner operates.

The bight itself includes a first branch 33 and a second branch 34, which extend downwardly (in FIG. 2) from a central arcuate drive segment 35. Drive segment 35 is engaged to teeth 36 of a pinion gear 40. The pinion gear is journaled to the carriage, and is driven by a bi-directional motor 41.

The teeth on the pinion gear are those which are intended to be engaged by whatever gear belt is specified and which will fully and tightly engage the gear teeth in the drive segment 35 where they are engaged. The drive segment will ordinarily be about 20 degrees less than a 180 degree bend, depending on the angles between branches.

To establish the shape and location of the bight, primary idlers 50,51 are mounted to the carriage. They press downwardly against the dynamic belt at their tangent to the static gear belt defining the start of the upward branches of the bight. The outer diameter of the idlers define the ▪reverse▪ bend of the belt. Additional secondary idlers 52,53 assure the engagement of the static and dynamic teeth before and after they encounter the primary idlers.

It is necessary to establish the correct length and tension of the belt in the bight. For this purpose adjustment means is provided for all of the idlers to place them at a height relative to the fixed gear belt so that they will press the teeth of the dynamic gear belt into the teeth of the static gear belt on the sides of the bight. They are freely rotatable, and do not exert any drag or driving force.

The pinion gear, through its motor, is adjustably mounted by the carriage for upward and downward. This tightens the belt and establishes the linear length of the belt in the bight.

This arrangement is sometimes called a ▪forcer▪ 54, because in operation it will force the dynamic belt linearly along the bight and move the carriage and the reference belt relative to one another. The term ▪forcer▪ defines the construction between idlers, when the forces on the bight causes relative movement to the carriage and the base.

It will be recognized that objects to be positioned will be related to whatever one of the carriages or base is movable. That is, the carriage may be held against movement while the base moves, or vise versa as required by the installation.

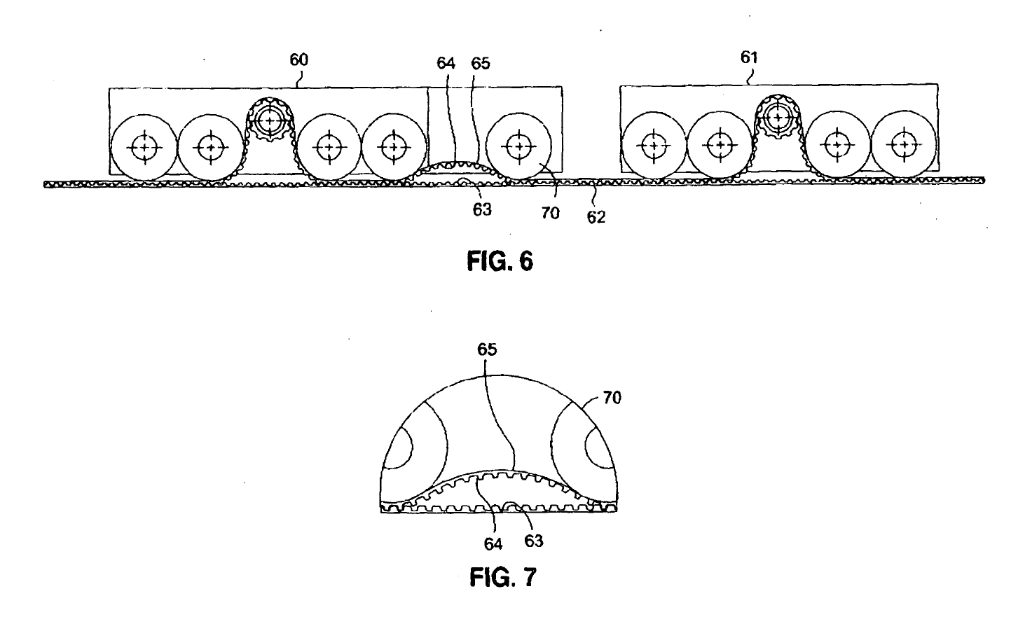

There may be some installations where more than one of the forcers will be employed on the same base. FIGS. 6 and 7. schematically shows a first forcer 60 identical to forcer 54, and a second identical forcer 61, both being independently movable relative to the same base 62 with a common fixed static reference gear belt 63 and dynamic gear belt 64. The problem as will be discussed below is that if the dynamic belt 64 were continuously engaged to both forcers, the exertions of one forcer could intrude on the accuracy of the other.

This consequence can be avoided by providing a discontinuity in the engagement of the two belts anywhere between the two forcers. An example is shown in FIG. 6 in which a disengaged portion 65 is shown as an arch including teeth not engaged to the static gear belt.

This discontinuity can be provided by an outrigger idler 70 between the two forcers. When the dynamic belt is installed it will include a number (one is sufficient but inconvenient) of teeth 71 that are disconnected. Idler 70 will press gear teeth together without regard to this discontinuity, but the discontinuity remains as a separation of the two forcers.

In the operation of this device, rotation of the pinion moves the bight along the static belt. For example in FIGS. 3-5, clockwise rotation of the pinion. This movement causes counter clockwise rotation of the idlers (as shown in FIG. 3), as the left hand branch 25 of the bight moves upwardly and the right hand branch moves downwardly. The idlers take no direct part in this movement, but do assure that the belts are engaged at the lower ends of the branches.

The nearly exact correlation between the gear teeth on the belts to the substantial elimination of backlash when movement is reversed is shown in FIGS. 4 and 5. Attention is called to the respective dynamics in these two details.

In FIG. 4, face 90 of tooth 91 is in engagement because dynamic belt 25 is pulling on oppositely facing face 93 of tooth 94 on the static belt.

At the same time in FIG. 3, which shows these other idlers, the dynamic belt is pulled by the moving base. Tooth faces 95 and 96 are engaged.

Now reverse the rotation of the idler gear. This same tooth faces are again in driving/driver relationship without backlash. In this reverse direction, the pull is on branch 34 and the base pulls on the other branch. Thus backlash is nearly entirely eliminated, except at the pinion gear, where the teeth are generally fully engaged. Backlash errors that could result from conditions in loops and branches are at least greatly reduced, because of the short lengths of their branches. The bight is the only part of the forcer in which the two gear belts are not tightly engaged.

This illustration shows the forcer fixed and the base movable. This arrangement can be reversed by fixing the base and permitting the carriage to move. The function of the forcer is identical in both situations.

In all embodiments, the engagement of the two gear belts apart from the bight assures cleanness of the engaged portions.

The location of the carriage relative to the base can be established at the set up time, at which time the dynamic gear belt is tightened and the geometry is established. Then position merging devices may be used, to determine where the positioner has placed the elements. One technique is to count revolutions of the pinion gear, knowing the movement caused by a revolution and its fractions.

Another technique is to place sensors on the device to read-out the attended locations. These are within the capacity of a skilled person in the art to devise.

Accordingly, with this elegantly simple system, very close and repeatable movements are enabled. The device works well in ▪dirty▪ environments as well as clean ones. It is economical to build and operate.

This invention is not to be limited by the embodiments shown in the drawings and described in the description, which are given by way of example and not of limitation, but only in accordance with the scope of the appended claims.

What is claimed is:

1. A positioner for causing relative axial movement between a base and a carriage, said positioner comprising:
a static gear belt with a linear axis and gear teeth on one of its surface, its other surface being attachable to said base, flat with its teeth laying in a plane;
a dynamic gear belt, said gear belt being flexible and substantially inextensible, having teeth drivingly and drivingly engageable with the teeth of the static gear belt, said dynamic gear belt being bent to form a bight with a central portion and two branches, and having lengths engaged with said static gear belt on either side of said bight, said bight comprising a discontinuity in the otherwise continuous engagement of the gear belts.
a pinion gear engaged to said dynamic gear belt in the said central portion of the bight; and journaled to said carriage;
a bi-directional power means to rotate said pinion gear;
a pair of idlers, one at the end of each branch from said central portion, each receiving a respective said length, bending it and pressing its teeth into the teeth of the static gear belt;
whereby upon rotation of the pinion gear one of the branches of said bight will be drawn toward the pinion gear, causing relative movement of the carriage and base, said movement causing the other branch of the bight to re-engage with said static gear belt.

2. A positioner according to claim 1 in which said pinion gear and idler gears are mounted to said carriage, said pinion gear mounted to said carriage in such manner as to be adjustable along the bisector of the angle formed with the pinion gear by the two said branches for tightening the dynamic belt onto the pinion gear and assuring engagement of the two gear belts beyond the bight.

3. A positioner according to claim 1 in which said carriage is mounted to a rail on said base.

4. A positioner according to claim 1 in which a plurality of idlers are mounted to said carriage distributed on each side of the first named pair of idlers further to assure engagement of the two gear belts.

5. A positioner according to claim 1 in which a second carriage is mounted to said base, forming a second said bight in said dynamic gear belt.

6. A positioner according to claim 4 in which an outrigger idler is rotatably mounted to said carriage, for maintaining a discontinuity in the joinder of the two gear belts between said first and second carriage.

7. A positioner according to claim 1 in which the form of the teeth on said gears provides for tooth-to-tooth contact for driving and for being driven without substantial backlash when reversed.

8. A positioner according to claim 1 in which the static gear belt is made of rigid plastic material or of metal having the stated gear form.
